(19) United States
(12) Patent Application Publication
(10) Pub. No.: US 2025/0282259 A1
(43) Pub. Date: Sep. 11, 2025

(54) SEAT SWITCH DEVICE AND SEAT INCLUDING THE SAME

(71) Applicant: TOYOTA JIDOSHA KABUSHIKI KAISHA, Toyota-shi (JP)

(72) Inventor: Kazuhiro KAWACHI, Miyoshi-shi (JP)

(73) Assignee: TOYOTA JIDOSHA KABUSHIKI KAISHA, Toyota-shi (JP)

(21) Appl. No.: 19/051,339

(22) Filed: Feb. 12, 2025

(30) Foreign Application Priority Data
Mar. 5, 2024 (JP) 2024-033245

(51) Int. Cl. B60N 2/02; B60N 2/12

(52) U.S. Cl. CPC B60N 2/0228; B60N 2/12

(57) ABSTRACT

A seat switch device capable of preventing unintentional operation of a seat, and a seat including the same, are provided.

A seat switch device 10 including a base portion 22 and an operation knob 30 for operating a seat 90 (see FIG. 4). The operation knob 30 is provided at a device front side with respect to the base portion 22. The seat switch device 10 also includes a guard member 50 that is provided at the device front side with respect to the base portion 22. The guard member 50 functions so as to guard the operation knob 30.

### CROSS-REFERENCE TO RELATED APPLICATION

This application is based on and claims priority under 35 USC 119 from Japanese Patent Application No. 2024-033245, filed on Mar. 5, 2024, the disclosure of which is incorporated by reference herein.

### BACKGROUND

### Technical Field

The present disclosure relates to a seat switch device and to a seat including the same.

### Related Art

A seat switch device (slide-switch structural body) including an operation knob (slide knob and reclining knob) is disclosed in Japanese Patent Application Laid-Open (JP-A) No. 2010-251028.

### SUMMARY

In the seat switch device configured as described above, there is a possibility that a seat might be operated unintentionally were some sort of object to hit the operation knob.

An object of the present disclosure is to provide a seat switch device capable of preventing operation of a seat unintentionally, and a seat provided with the same.

A seat switch device according to a first aspect includes a base portion, an operation knob that operates a seat and that is provided at a device front side with respect to the base portion, and a guard member that is provided at the device front side with respect to the base portion and that guards the operation knob.

In the first aspect, the seat switch device includes the base portion and the operation knob that operates the seat. The operation knob is provided at the device front side with respect to the base portion.

This thereby enables the base portion to be arranged at the inside of the exterior member, and the operation knob provided at the device front side with respect to the base portion to be arranged at the outside of an exterior member. The seat can then be operated by the hand of an occupant touching the operation knob and moving the operation knob.

However, with a seat switch device merely configured as described above, there would be a possibility that a seat might be operated unintentionally were some sort of object to hit the operation knob.

Thus in the first aspect, the seat switch device includes the guard member provided at the device front side with respect to the base portion. The guard member functions so as to guard the operation knob.

Thus due to being able to dispose the guard member at the outside of the exterior member in the same way as the operation knob, objects hitting the operation knob can be prevented by the guard member. Unintentional operation of the seat can be prevented as a result.

Note that in exemplary embodiments described below the seat switch device is arranged with a device front side facing toward a vehicle width direction outside. However, the present aspect is not limited thereto. For example, the device front side may be aligned with a vehicle front side, or may be aligned with a vehicle rear side.

Note that in exemplary embodiments described below the guard member is fixed so as to be immovable with respect to the base portion. This thereby enables confusion of the occupant between the guard member and the operation knob to be prevented. However, the present aspect is not limited thereto, and the guard member may be configured so as to move with respect to the base portion.

Note that in the exemplary embodiments described below an end on the device front side of the guard member is positioned further toward the device front side than an end on the device front side of the operation knob. However, the present aspect is not limited thereto.

Note that in the exemplary embodiments described below the guard member includes a covering portion that covers the operation knob from the device front side. However, the present aspect is not limited thereto.

A seat switch device according to a second aspect is the first aspect, wherein an end at a device front side of the guard member is positioned further toward the device front side than an end at a device front side of the operation knob.

In the second aspect, the end at the device front side of the guard member is positioned further toward the device front side than the end at the device front side of the operation knob.

This thereby enables objects to be effectively prevented from hitting the operation knob.

Note that in exemplary embodiments described below the guard member includes a covering portion that covers the operation knob from the device front side. However, the present aspect is not limited thereto.

A seat switch device according to a third aspect is the first or the second aspect, wherein the guard member includes a covering portion that covers the operation knob from the device front side.

In the third aspect, the guard member includes the covering portion that covers the operation knob from the device front side.

This thereby enables objects to be effectively prevented from hitting the operation knob from the device front side by the covering portion.

A seat switch device according to a fourth aspect is any of the first aspect to the third aspect, wherein the guard member includes an outer face portion configuring an outer face of the guard member, and the outer face portion includes a top face portion configuring a top face facing toward the device front side with the top face portion covering the operation knob from the device front side, and a side face portion configuring a side face facing in a direction perpendicular to a device front direction.

In the fourth aspect, the guard member includes the outer face portion configuring the outer face of the guard member. The outer face portion includes the top face portion configuring the top face facing toward the device front side, and the side face portion configuring the side face facing in the direction perpendicular to the device front direction.

The durability of the guard member is accordingly readily secured while securing good styling.

Moreover, in the fourth aspect the top face portion covers the operation knob from the device front side.

This thereby enables the top face portion of the guard member to function as a covering portion covering the operation knob from the device front side.

A seat switch device according to a fifth aspect is the fourth aspect, wherein the side face portion includes an opening exposing a portion of the operation knob.

In a fifth aspect, the side face portion includes the opening exposing a portion of the operation knob.

The side faces of the guard member are accordingly positioned on each side of the opening exposing a portion of the operation knob. As a result thereof, the guard member can effectively function as an operation guide for operating the operation knob.

Note that in the exemplary embodiments described below, a portion of the operation knob is visible through the opening in the guard member when viewed from the device front side. This accordingly facilitates operation of the operation knob. However, the present aspect is not limited thereto, and the entire operation knob may be hidden when viewed from the device front face.

A seat switch device according to a sixth aspect is any one of the first aspect to the fifth aspect, wherein the guard member includes a covering portion that covers the operation knob from the device front side, and two pillar portions that support the covering portion from a device rear side with the two pillar portions respectively disposed on each side of the operation knob.

In the sixth aspect, the guard member includes the covering portion that covers the operation knob from the device front side and the two pillar portions that support the covering portion from the device rear side. The two pillar portions are disposed on each side of the operation knob.

When, for example, load toward the device rear side has acted on the guard member, the covering portion can be appropriately supported by the two pillar portions. The durability of the guard member is readily secured as a result.

A seat switch device according to a seventh aspect is any one of the first aspect to the sixth aspect, wherein the seat switch device includes a guard projection portion that projects from the base portion toward the device front side, and the pillar portions include a side face portion configuring a side face facing in a direction perpendicular to a device front direction, and a fitting portion that fits together with the guard projection portion.

In the seventh aspect, the seat switch device includes the guard projection portion that projects from the base portion toward the device front side. The pillar portions include the side face portion configuring the side face facing in the direction perpendicular to the device front direction, and the fitting portion that fits together with the guard projection portion.

The covering portion can accordingly be more effectively supported than cases in which, for example, the pillar portions are not provided with the fitting portion. The durability of the guard member is accordingly readily secured as a result.

A seat switch device according to an eighth aspect is any one of the first aspect to the seventh aspect, wherein the seat switch device is arranged with a device front side facing toward a seat width direction out side, the operation knob operates a seatback, the guard member has a shape with a length direction substantially along a seat height direction, the guard member includes side face portions configuring side faces of the guard member, and among the side faces, a rear side face facing toward a seat rear side extends in a direction inclined toward a seat rear on progression in a seat upward direction.

In the eighth aspect, the seat switch device is arranged with the device front side facing toward the seat width direction outside, and the operation knob is an operation knob for operating the seatback. The guard member has a shape with a length direction substantially along the seat height direction.

An occupant is accordingly able, by touching the guard member and gripping the profile thereof (the shape with a length direction substantially along the seat height direction), to recognize that this is the guard member corresponding to the operation knob for operating the seatback.

Moreover, in the eighth aspect the guard member includes the side face portion configuring the side face of the guard member. From out of the side faces, the rear side face facing toward the seat rear side extends in the direction inclined toward the seat rear on progression in the seat upward direction.

Any finger other than the thumb of the occupant is accordingly easily placed along the side face of the guard member facing the rear side. The operability can be improved as a result thereof.

Note that in the exemplary embodiments described below a side face of the guard member facing the front side also extends in a direction inclined toward the seat rear on progression in the seat upward direction. However, the present aspect is not limited thereto.

Note that “substantially along the seat height direction” is a definition encompassing the seat height direction, and means a direction inclined in a range of ±40° with respect to the seat height direction.

A seat switch device according to a ninth aspect is any one of the first aspect to the seventh aspect, wherein the seat switch device is arranged with a device front side facing toward a seat width direction out side, the operation knob operates a seat cushion, the guard member has a shape with a length direction along a seat front-rear direction, the guard member includes side face portions configuring side faces of the guard member, and among the side faces, a lower side face facing in a seat downward direction extends in the seat front-rear direction.

In the ninth aspect, the seat switch device is arranged with the device front side facing toward the seat width direction outside, and the operation knob is the operation knob for operating the seat cushion. The guard member has a shape with the length direction along the seat front-rear direction.

Thus by touching the guard member and gripping the profile thereof (the shape with a length direction along the seat front-rear direction), the occupant is able to recognize that this is the guard member corresponding to the operation knob for operating the seat cushion.

Moreover, in the ninth aspect, the guard member includes the side face portions configuring the side faces of the guard member. From out of the side faces, the lower side face facing toward the seat downward side extends along the seat front-rear direction.

This means that any finger other than the thumb of the occupant is easily placed along the lower side face of the guard member. The operability can be improved as a result.

Note that in the exemplary embodiments described below, from out of the side faces of the guard member, the upper side face facing the seat upper side extends also along the seat front-rear direction. However, the present aspect is not limited thereto.

A seat according to a tenth aspect includes the seat switch device according to any one of the first aspect to the ninth aspect.

In the tenth aspect, the seat includes the seat switch device described above.

A seat can accordingly be realized that is capable of preventing unintentional operation of the seat.

As described above, the present disclosure provides a seat switch device capable of preventing unintentional operation of a seat, and a seat including the same.

### BRIEF DESCRIPTION OF THE DRAWINGS

Exemplary embodiments of the present disclosure will be described in detail based on the following figures, wherein:

FIG. 1 is an exploded perspective diagram of a seat switch device of an exemplary embodiment;

FIG. 2 is a front view of part of a seat switch device of an exemplary embodiment as viewed from in front of the device;

FIG. 3 is an expanded perspective view of a first operation knob; and

FIG. 4 is a schematic side view of a seat including a seat switch device.

### DETAILED DESCRIPTION

Description follows regarding a seat switch device 10 according to an exemplary embodiment of the present disclosure, and a seat 90 provided with the same.

Note that in the drawings, as appropriate, arrow FR indicates a vehicle front direction, arrow UP indicates a vehicle upward direction, and arrow OUT indicates a vehicle width direction outside. Moreover, in the present exemplary embodiment, the device front side of the seat switch device 10 is aligned with the vehicle width direction outside.

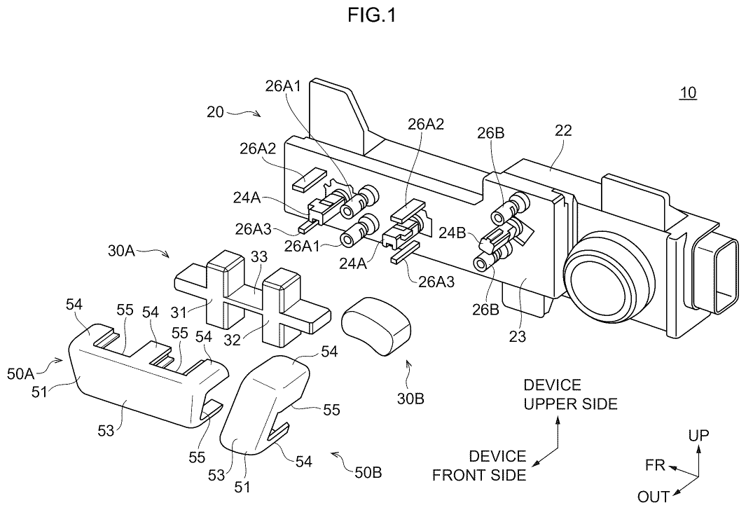

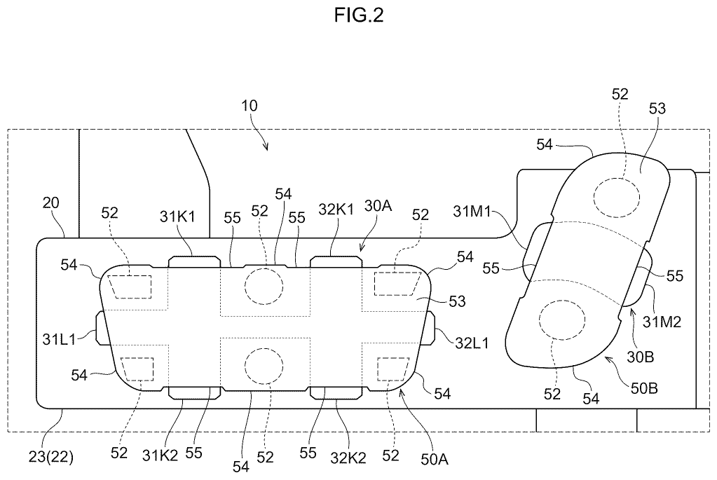

FIG. 1 is an exploded perspective view of the seat switch device 10, and FIG. 2 is a front view of part of the seat switch device 10, as viewed from in front of the device. Note that FIG. 2 schematically depicts parts hidden by other members using broken lines.

As illustrated in FIG. 1, the seat switch device 10 includes a main body 20, a first operation knob 30A, a second operation knob 30B, a first guard member 50A, and a second guard member 50B. The first operation knob 30A and the second operation knob 30B will simply be referred to as operation knob 30 when not particularly distinguishing therebetween. The first guard member 50A and the second guard member 50B will also simply be referred to as guard member 50 when not particularly distinguishing therebetween.

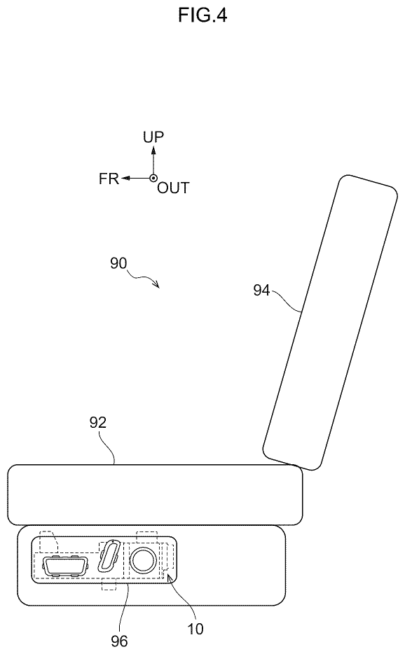

The operation knob 30 is a knob for operating the seat 90 (see FIG. 4). Specifically, the first operation knob 30A is an operation knob for operating a seat cushion 92. The second operation knob 30B is an operation knob for operating a seatback 94.

Operations of the seat cushion 92 include a slide operation, a vertical operation, and a lift operation. The slide operation means an operation to move of the seat cushion 92 in the front-rear direction. The vertical operation means an operation to move a front end portion of the seat cushion 92 in the height direction. A lift operation means an operation to move the entire seat cushion 92 in the height direction. Operation of the seatback 94 includes a reclining operation.

The guard members 50 are members to guard the operation knobs 30. In other words, the guard members 50 function so as to prevent operation of the operation knobs 30 were an object to unintentionally hit the operation knobs 30. The first guard member 50A corresponds to the first operation knob 30A, and the second guard member 50B corresponds to the second operation knob 30B.

The main body 20 includes a base portion 22, a plurality of operation projection portions 24A, 24B projecting from the base portion 22 toward the device front side, and a plurality of guard projection portions 26A1, 26A2, 26A3, 26B that project from the base portion 22 toward the device front side.

The base portion 22 includes a case 23, and in-built components (non-illustrated) are housed in the case 23.

The plural operation projection portions 24A, 24B include a plurality of (two) first operation projection portions 24A and a single second operation projection portion 24B. These will simply be referred to as operation projection portions 24 when not particularly distinguishing therebetween.

The first operation knob 30A is attached to the plural first operation projection portions 24A. The second operation knob 30B is attached to the second operation projection portion 24B.

The operation projection portions 24 are moved by an occupant moving the operation knobs 30, with contact states inside the case 23 being switched thereby. This thereby enables the seat 90, which is a power seat, to be operated.

The plural guard projection portions 26A1, 26A2, 26A3, 26B including plural (six) first guard projection portions 26A1, 26A2, 26A3, and plural (two) second guard projection portions 26B. These will simply be referred to as guard projection portions 26 when not particularly distinguishing therebetween.

The first guard member 50A is attached to the plural first guard projection portions 26A1, 26A2, 26A3. The second guard member 50B is attached to the plural second guard projection portions 26B.

The guard projection portions 26 are fixed so as to be immovable with respect to the base portion 22. This means that the guard members 50 are also fixed immovable with respect to the base portion 22.

Note that a vehicle seat exterior member 96 (seat side shield, see FIG. 4) is arranged at the device front side of the base portion 22. Holes are formed in the seat side shield for the projection portions 24, 26 to respectively pass through, with each of the projection portions 24, 26 being in a state projecting through these holes to outside the vehicle seat exterior member 96. The operation knob 30 and the guard member 50 are attached to each of the projection portions 24, 26 in this state.

Next, detailed description follows regarding configuration related to the first guard member 50A.

The two first operation projection portions 24A include a first operation projection portion 24A at a vehicle front side and a first operation projection portion 24A a vehicle rear side.

The six first guard projection portions 26A1, 26A2, 26A3 include two central guard projection portions 26A1, and four outside guard projection portions 26A2, 26A3.

The central guard projection portions 26A1 are attached to a front-rear direction center portion of the first guard member 50A. The front two outside guard projection portions 26A2, 26A3 are attached to a front end portion of the first guard member 50A, and the rear two outside guard projection portions 26A2, 26A3 are attached to a rear end portion of the guard member 50.

The central guard projection portions 26A1 each have a substantially circular pillar shape with an axis along the device front-rear direction. The outside guard projection portions 26A2, 26A3 each have a plate shape with a plate thickness directions facing in the device height direction. The height dimension of the central guard projection portions 26A1 is larger than the height dimension of the outside guard projection portions 26A2, 26A3.

The four outside guard projection portions 26A2, 26A3 include two upper guard projection portions 26A2 and two lower guard projection portions 26A3. The width dimension (seat front-rear direction dimension) of the upper guard projection portions 26A2 is larger than the width direction of the lower guard projection portions 26A3.

As illustrated in FIG. 2, the first operation knob 30A includes a pair of vertical exposed portions 31K1, 31K2, a pair of lift exposed portions 32K1, 32K2, and a pair of slide exposed portions 31L1, 32L1.

The occupant is able to perform a vertical operation on the seat cushion 92 by pressing one or other of the pair of vertical exposed portions 31K1, 31K2.

The occupant is able to perform a lift operation on the seat cushion 92 by pressing one or other of the pair of lift exposed portions 32K1, 32K2.

The occupant is able to perform a slide operation on the seat cushion 92 by pressing one or other of the pair of slide exposed portions 31L1, 32L1.

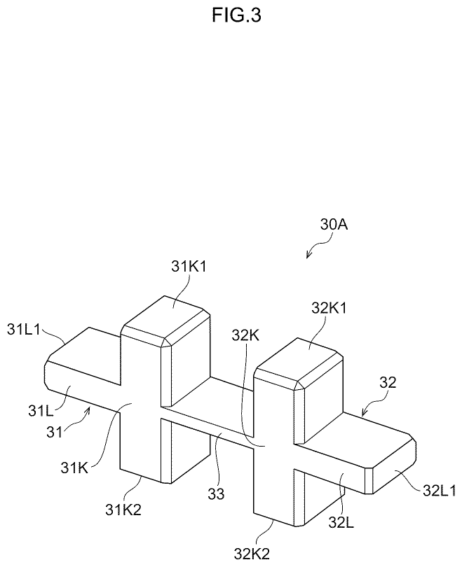

As illustrated in FIG. 3, the first operation knob 30A includes a front portion 31, a rear portion 32, and a coupling portion 33 coupling the front portion 31 and the rear portion 32 together in the front-rear direction.

The pair of vertical exposed portions 31K1, 31K2 and the front slide exposed portion 31L1 are formed to the front portion 31. The pair of lift exposed portions 32K1, 32K2 and the rear slide exposed portion 32L1 are formed to the rear portion 32. The front portion 31 is attached to the first operation projection portion 24A at the front side from out of the two first operation projection portions 24A. The rear portion 32 is attached to the first operation projection portion 24A at the rear side from out of the two first operation projection portions 24A.

The front portion 31 includes an up-down extension portion 31K extending in the height direction, and a forward extension portion 31L extending in a forward direction from the up-down extension portion 31K. The forward extension portion 31L is arranged between the two outside guard projection portions 26A2, 26A3 on the front side.

The rear portion 32 includes an up-down extension portion 31K extending in the height direction, and a rear extension portion 32L extending in a rearward direction from the up-down extension portion 32K. The rear extension portion 32L is arranged between the two outside guard projection portions 26A2, 26A3 at the rear side.

The coupling portion 33 is arranged between the two central guard projection portions 26A1.

The first guard member 50A includes an outer face portion 51 configuring an outer face of the first guard member 50A, and plural fitting portions 52 (see FIG. 2) that fit together with the plural first guard projection portions 26A1, 26A2, 26A3. The fitting portions 52 are provided at the inside of the outer face portion 51 so as not to be visible to the occupant.

The outer face portion 51 includes a top face portion 53 configuring a top face facing the device front side, and side face portions 54 configuring side faces facing in directions perpendicular to the device front direction. The outer face portion 51 is configured such that the top face and the side faces are connected together by smooth curved faces. The top face portion 53 of the first guard member 50A is configured to cover the first operation knob 30A from the device front side. In the following the top face portion 53 of the first guard member 50A is sometimes referred to as a covering portion 53.

The side face portions 54 of the first guard member 50A include plural (six) openings 55 that expose the exposed portions 31K1, 31K2, 32K1, 32K2, 31L1, 32L1 of the first operation knob 30A. The plural openings 55 are provided in a number corresponding to the plural number of the exposed portions 31K1, 31K2, 32K1, 32K2, 31L1, 32L1. The side face portions 54 are separated into plural (six) portions 54 by the plural openings 55. In the following the respective separated portions 54 are sometimes referred to as side face portions 54.

As illustrated in FIG. 2, from out of the six separated side face portions 54, four side face portions 54 are positioned at the four corners of the first guard member 50A formed in a substantially quadrangular shape (specifically a trapezoidal shape) when looking at the device front face. The side faces where the four side face portions 54 are formed at the four corner positions are configured by smooth curved faces.

Next, detailed description follows regarding configuration related to the second guard member 50B. Note that the same reference numerals will be appended in the drawings to similar configuration to the configuration related to the first guard member 50A.

As illustrated in FIG. 1, the plural second guard projection portions 26B include an upper second guard projection portion 26B and a lower second guard projection portion 26B. The upper second guard projection portion 26B is positioned further to the seat rear side than the lower second guard projection portion 26B.

As illustrated in FIG. 2, the second operation knob 30B includes a pair of reclining exposed portions 31M1, 31M2.

The occupant is able to perform a reclining operation on the seatback 94 by pressing one or other of the pair of reclining exposed portions 31M1, 31M2.

The second operation knob 30B is attached to the second operation projection portions 24B.

The second operation knob 30B has a shape that extends in substantially the seat front-rear direction. A front end portion of the second operation knob 30B is configured by the front reclining exposed portion 31M1, and a rear end portion of the second operation knob 30B is configured by the rear reclining exposed portion 31M2. The second operation knob 30B is arranged between an upper second guard projection portion 26B and a lower second guard projection portion 26B.

As illustrated in FIG. 2, the second guard member 50B has a shape with a length direction substantially along the seat height direction. Specifically, the second guard member 50B has a shape with a length direction along a direction inclined slightly toward the seat rear side on progression in the seat upward direction.

The second guard member 50B includes an outer face portion 51 configuring an outer face of the second guard member 50B, and two fitting portions 52 that fit together with the two second guard projection portions 26B. The fitting portions 52 are provided at the inside of the outer face portion 51 so as not to be visible to the occupant.

The outer face portion 51 includes a top face portion 53 configuring a top face facing the device front side, and side face portions 54 configuring side faces facing in directions perpendicular to the device front direction. The outer face portion 51 is configured such that the top face and the side faces are connected together by smooth curved faces. The top face portion 53 of the second guard member 50B is configured to cover the second operation knob 30B from the device front side. In the following the top face portion 53 of the second guard member 50B is sometimes referred to as a covering portion 53.

The side face portions 54 of the second guard member 50B include two openings 55 that expose plural exposed portions 31M1, 31M2 of the second operation knob 30B. The plural openings 55 are provided in a number corresponding to the plural number of the exposed portions 31M1, 31M2. The side face portions 54 are separated into two portions 54 by the two openings 55. In the following the respective separated portions 54 are sometimes referred to as side face portions 54.

### Operation and Advantageous Effects

Next, description follows regarding the operation and advantageous effects of the present exemplary embodiment.

In the present exemplary embodiment, as illustrated in FIG. 1 and FIG. 2, the seat switch device 10 includes the base portion 22, and the operation knobs 30 for operating the seat 90 (see FIG. 4). The operation knobs 30 are provided at the device front side with respect to the base portion 22.

This means that base portion 22 can be arranged inside the vehicle seat exterior member 96 (see FIG. 4), and the operation knobs 30 provided at the device front side with respect to the base portion 22 can be arranged at the outside of the vehicle seat exterior member 96. The occupant is accordingly able to operate the seat 90 by touching the operation knobs 30 and moving the operation knobs 30.

In the seat switch device 10 configured as described above, were some type of object to hit the operation knobs 30, there would be a possibility that the seat 90 might be operated unintentionally.

Thus in the present exemplary embodiment, the seat switch device 10 includes the guard members 50 provided at the device front side with respect to the base portion 22. The guard members 50 function so as to guard the operation knobs 30.

This accordingly enables the guard members 50 to, the same as the operation knobs 30, be arranged at the outside of the vehicle seat exterior member 96, enabling an object hitting the operation knobs 30 to be prevented by the guard members 50. As a result thereof unintentional operation of the seat 90 can be prevented.

Moreover, in the present exemplary embodiment, ends (top face portions 53) at the device front side of the guard members 50 are positioned further to the device front side than the device front side ends of the operation knobs 30.

This thereby enables an object to be effectively prevented from hitting the operation knobs 30.

Moreover, in the present exemplary embodiment, the guard members 50 each include the covering portion 53 covering the operation knob 30 from the device front side.

This thereby enables an object hitting the operation knob 30 from the device front side to be effectively prevented by the covering portion 53.

Moreover, in the present exemplary embodiment, the guard members 50 each include the outer face portion 51 configuring the outer face of the guard member 50. The outer face portion 51 includes the top face portion 53 configuring the top face facing toward the device front side, and the side face portions 54 configuring side faces facing in directions perpendicular to the device front direction.

This accordingly means that the durability of the guard member 50 is easily secured while also securing good styling.

In particular, in the present exemplary embodiment, the outer face portion 51 is configured such that the top face and the side faces are connected by smooth curved faces.

The guard member 50 accordingly secures a pleasant feeling to the touch.

Moreover, in the present exemplary embodiment, the top face portion 53 covers the operation knob 30 from the device front side.

This accordingly enables the top face portion 53 of the guard member 50 to function as the covering portion 53 covering the operation knob 30 from the device front side.

Moreover, in the present exemplary embodiment, the side face portions 54 include the openings 55 that expose portions of the operation knobs 30.

This means that side faces of the guard members 50 are positioned on each side of the respective openings 55 that expose portions of the operation knob 30. As a result thereof, the guard members 50 can effectively function as operation guides for operation of the operation knobs 30.

In particular, in the present exemplary embodiment, as illustrated in FIG. 2, portions of each of the operation knobs 30 are visible from the openings 55 of the guard members 50 when looking from the device front side. This facilitates operation of the operation knobs 30.

Moreover, in the present exemplary embodiment, as illustrated in FIG. 2, the guard members 50 each include the covering portion 53 covering the operation knob 30 from the device front side, and the two pillar portions 52, 54 supporting the covering portion 53 from the device rear side. The two pillar portions 52, 54 are arranged on each side of the operation knobs 30.

Thus when, for example, load toward the device rear side has acted on the guard member 50, the covering portion 53 can be appropriately supported by the two pillar portions 52, 54. As a result thereof, durability of the guard member 50 is easily secured.

Moreover, in the present exemplary embodiment, as illustrated in FIG. 1, the seat switch device 10 includes the guard projection portions 26 projecting toward the device front side from the base portion 22. Moreover, as illustrated in FIG. 2, pillar portions 52, 54 include the side face portions 54 configuring the side faces facing in directions perpendicular to the device front direction, and the fitting portions 52 for fitting together with the guard projection portions 26.

This accordingly enables the covering portions 53 to be more effectively supported than cases in which, for example, the pillar portions 52, 54 do not include fitting portions 52. The durability of the guard members 50 is easily secured as a result.

Moreover, in the present exemplary embodiment, as illustrated in FIG. 4, the seat switch device 10 is arranged with the device front side facing toward the seat width direction outside, and the second operation knob 30B is the operation knob 30 for operating the seatback 94. As illustrated in FIG. 2, the second guard member 50B has a shape with a length direction substantially along the seat height direction.

This means that the occupant is able, by touching this guard member 50 and gripping the profile thereof (the shape with a length direction substantially along the seat height direction), to recognize that this is the second guard member 50B corresponding to the second operation knob 30B for operating the seatback 94.

Moreover as illustrated in FIG. 2, in the present exemplary embodiment the second guard member 50B includes the side face portions 54 configuring the side faces of the second guard member 50B. From out of the side faces of the second guard member 50B, the rear side face facing the seat rear side extends in direction inclined toward the seat rear on progression in the seat upward direction.

This means that any finger other than the thumb of the occupant is easily placed along the side face of the guard member 50 facing the rear side. An improvement in operability can be achieved as a result thereof.

Moreover as illustrated in FIG. 4, in the present exemplary embodiment, the seat switch device 10 is device disposed with the device front side facing toward the seat width direction outside, and the first operation knob 30A is the operation knob 30 for operating the seat cushion. The first guard member 50A accordingly has a shape with a length direction along the seat front-rear direction.

This means that, by touching this guard member 50 and gripping the profile thereof (the shape with a length direction along the seat front-rear direction), the occupant is able to recognize that this is the first guard member 50A corresponding to the first operation knob 30A for operating the seat cushion 92.

Moreover as illustrated in FIG. 2, in the present exemplary embodiment the first guard member 50A includes the side face portions 54 configuring the side faces of the first guard member 50A. From out of the side faces of the first guard member 50A, the lower side face facing the seat downward side extends along the seat front-rear direction.

Any finger other than the thumb of the occupant is accordingly easily placed along the lower side face of the first guard member 50A. An improvement in operability can be achieved as a result thereof.

Moreover as illustrated in FIG. 4, in the present exemplary embodiment the seat switch device 10 is arranged with the device front side facing toward the vehicle width direction outside.

This means that, for example, there might be a concern regarding door trim of a side door hitting the operation knob 30 when a side-impact collision occurred, and regarding the seat 90 being unintentionally operated.

However, in the present exemplary embodiment, the guard member 50 is provided and so unintentional operation when a side-impact collision occurs can be prevented.

Moreover, in the present exemplary embodiment, as illustrated in FIG. 2, the first guard member 50A has a shape that is an elongated trapezoidal shape, with a longer upper base than lower base as viewed from the device front side.

This means that the occupant easily grips the first guard member 50A, and good operability is secured.

Furthermore, in the present exemplary embodiment, the upper guard projection portions 26A2 have width dimensions larger than the lower guard projection portions 26A3.

This thereby enables the guard projection portions 26 to be made large effectively within limitations to the shape of the first guard member 50A as described above. The durability of the first guard member 50A is readily secured as a result thereof.

Moreover, in the present exemplary embodiment, as illustrated in FIG. 1, the front portion 31 and the rear portion 32 of the first operation knob 30A are connected together by the coupling portion 33.

This means that the number of components can be reduced compared to cases in which the first operation knob 30A is separated into the front portion 31 and the rear portion 32.

Furthermore, in the present exemplary embodiment the central guard projection portions 26A1 are arrange above and below the coupling portion 33. As illustrated in FIG. 3, the coupling portion 33 has a height dimension that is smaller than that of either the forward extension portion 31L or the rear extension portion 32L.

This means that the size of the central guard projection portions 26A1 is readily secured. The durability of the first guard member 50A is readily secured as a result thereof. In the present exemplary embodiment, the height dimension of the central guard projection portions 26A1 is actually larger than the height dimension of the outside guard projection portions 26A2, 26A3.

Moreover as illustrated in FIG. 2, in the present exemplary embodiment the radius of curvature at a boundary position between the rear side face and the lower side face of the second guard member 50B is greater than the radius of curvature at a boundary position between the front side face and the lower side face.

This means that the radius of curvature is large at a position where the ball of the finger of the occupant is liable to be positioned, raising operability.

Moreover as illustrated in FIG. 2, in the present exemplary embodiment, the radius of curvature at a boundary position between the front side face and the upper side face of the second guard member 50B is larger than the radius of curvature at a boundary position between the rear side face and the upper side face.

This means that the radius of curvature is large at the position where the thenar eminence of the occupant is liable to be positioned, and operability is raised.

### Supplementary Explanation to Above Exemplary Embodiments

Note that in the above exemplary embodiments the first guard member 50A and the second guard member 50B are provided so as to respectively correspond to the first operation knob 30A and the second operation knob 30B. However, the present disclosure is not limited thereto, and a guard member corresponding to only one of the operation knobs may be provided alone.

Moreover, the direction of movement of the operation knob 30 in the above exemplary embodiment is a direction perpendicular to the device front-rear direction. However, the present disclosure is not limited thereto.

Moreover, in the above exemplary embodiments the seat switch device 10 includes the guard projection portions 26 projecting from the base portion 22 toward the device front side. However, the present disclosure is not limited thereto.

### EXPLANATION OF REFERENCE NUMERALS

10 seat switch device
22 base portion
26A1, 26A2, 26A3 first guard projection portion (guard projection portion)
26B second guard projection portion (guard projection portion)
30A first operation knob (operation knob)
30B second operation knob (operation knob)
50A first guard member (guard member)
50B second guard member (guard member)
51 outer face portion
52 fitting portion (pillar portion)
53 top face portion (covering portion)
54 side face portion (pillar portion)
55 opening
90 seat
92 scat cushion
94 seatback

What is claimed is:

1. A seat switch device, comprising:
a base portion;
an operation knob that operates a seat and that is provided at a device front side with respect to the base portion; and
a guard member that is provided at the device front side with respect to the base portion and that guards the operation knob.

2. The seat switch device of claim 1, wherein an end at a device front side of the guard member is positioned further toward the device front side than an end at a device front side of the operation knob.

3. The seat switch device of claim 1, wherein the guard member includes a covering portion that covers the operation knob from the device front side.

4. The seat switch device of claim 1, wherein:
the guard member includes an outer face portion configuring an outer face of the guard member; and
the outer face portion includes
a top face portion configuring a top face facing toward the device front side, with the top face portion covering the operation knob from the device front side, and
a side face portion configuring a side face facing in a direction perpendicular to a device front direction.

5. The seat switch device of claim 4, wherein the side face portion includes an opening exposing a portion of the operation knob.

6. The seat switch device of claim 1, wherein the guard member includes:
a covering portion that covers the operation knob from the device front side; and
two pillar portions that support the covering portion from a device rear side, with the two pillar portions respectively disposed on each side of the operation knob.

7. The seat switch device of claim 6, wherein:
the seat switch device includes a guard projection portion that projects from the base portion toward the device front side; and
the pillar portions include
a side face portion configuring a side face facing in a direction perpendicular to a device front direction, and
a fitting portion that fits together with the guard projection portion.

8. The seat switch device of claim 1, wherein:
the seat switch device is arranged with a device front side facing toward a seat width direction outer side;
the operation knob operates a seatback;
the guard member has a shape with a length direction substantially along a seat height direction;
the guard member includes side face portions configuring side faces of the guard member; and
among the side faces, a rear side face facing toward a seat rear side extends in a direction inclined toward a seat rear on progression in a seat upward direction.

9. The seat switch device of claim 1, wherein:
the seat switch device is arranged with a device front side facing toward a seat width direction outer side;
the operation knob operates a seat cushion;
the guard member has a shape with a length direction along a seat front-rear direction;
the guard member includes side face portions configuring side faces of the guard member; and
among the side faces, a lower side face facing in a seat downward direction extends in the seat front-rear direction.

10. A seat comprising the seat switch device of claim 1.
